(19) United States
(12) Patent Application Publication
(10) Pub. No.: US 2008/0217153 A1
(43) Pub. Date: Sep. 11, 2008

(54) Insulating Body For a Medium-Voltage Switchgear Assembly

(75) Inventors: Martin Bottcher, Berlin (DE); Stefan Hohmann, Petersberg (DE); Marcus Kampf, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/064,242

(22) PCT Filed: Aug. 16, 2006
(86) PCT No.: PCT/EP2006/065333

§ 371 Date: Feb. 20, 2008

(30) Foreign Application Priority Data
Aug. 22, 2005 (DE) 10 2005 040 298.4

(51) Int. Cl. H01H 31/02

(52) U.S. Cl. 200/48 R

(57) ABSTRACT

An insulating element for a medium-voltage switchgear has a terminal at the busbar end and an outgoing cable. A circuit-breaker is embedded in the insulating element. The insulating element supports a first contact point that is connected to the circuit-breaker and is used as a bearing point for a movable switching contact of a disconnector, and an additional contact point for the movable switching contact. A favorable structure for producing medium-voltage switchgears in general for primary and secondary power supply systems while reducing expenses, the additional contact point is also configured as a bearing point for the movable switching contact, the movable switching contact is alternatively mounted on the additional contact point rather than on the first contact point, and the additional contact point is alternatively connected to the outgoing cable rather than to the terminal at the busbar end.

The invention relates to an insulating body for a medium-voltage switchgear assembly with a connection on the busbar side and an outgoing cable, in which insulating body a circuit breaker is embedded and which bears a first contact point, which is connected to the circuit breaker, as the bearing point for a movable switching contact of a switch disconnector and a further contact point for the movable switching contact.

Such an insulating body is known from the international patent application WO 2004/040728. A circuit breaker together with an actuating mechanism is embedded in the insulating body, which is arranged in a gas-insulated medium-voltage switchgear assembly. A movable switching contact of a switch disconnector is mounted at a first contact point of the insulating body. The insulating body has a further contact point, the movable switching contact of the switch disconnector being capable of being pivoted about the first contact point between the further contact point and a grounding contact of the gas-insulated medium-voltage switchgear assembly. Given such an arrangement, a grounding operation is carried out by the movable switching contact being brought into connection with the grounding contact and switching contacts of the circuit breaker being closed. Such a grounding operation is conventional in the case of gas-insulated medium-voltage switchgear assemblies in primary energy distribution systems.

In addition, the document by Siemens AG “Mittelspannungsanlagen, Katalog HA41.11, 2002” [Medium-voltage assemblies, catalog HA41.11, 2002] has disclosed a gas-insulated medium-voltage assembly for secondary energy distribution systems in which a circuit breaker is accommodated in an insulating body. A switch disconnector is arranged separately from the insulating body in such a way that a grounding operation of the outgoing cable is possible without switching of the circuit breaker.

The object of the present invention is to design an insulating body of the type mentioned at the outset which allows for a favorable construction in terms of manufacturing technology of medium-voltage switchgear assemblies in general for primary and secondary energy distribution systems given at the same time a reduction in costs.

This object is achieved according to the invention in the case of an insulating body of the type mentioned at the outset by virtue of the fact that the further contact point is also in the form of a bearing point for the movable switching contact, which movable switching contact is optionally mounted at the further contact point instead of at the first contact point, and the further contact point is optionally connected to the outgoing cable instead of to the connection on the busbar side. Such an insulating body according to the invention can advantageously be used both in a gas-insulated and in an air-insulated medium-voltage switchgear assembly. With the insulating body according to the invention, simplified production of medium-voltage switchgear assemblies both for primary and for secondary energy distribution systems is possible since an insulating body with one and the same embodiment can be used for medium-voltage switchgear assemblies in the two energy distribution systems. In this case, the reduction in the number of different parts results in a reduction in the production costs.

Although the abovementioned international patent application WO 2004/040728 has disclosed connecting the further contact point of the insulating body optionally also to the outgoing cable, such an arrangement is only used for connecting voltage transformers or measuring equipment, for example. Grounding of the outgoing cable is in this case not possible.

In a preferred embodiment, the movable switching contact can be connected to a grounding contact by means of an actuating mechanism, which grounding contact is optionally arranged opposite the first contact point instead of opposite the further contact point. The optional arrangement of the grounding contact, as a result of the interaction with the movable switching contact, makes possible in a simple manner a grounding operation of the gas-insulated medium-voltage switchgear assembly in the respective configuration as an assembly for primary or for secondary energy distribution systems.

The invention will be explained in more detail in the text which follows using the drawing and an exemplary embodiment with reference to the figures, in which:

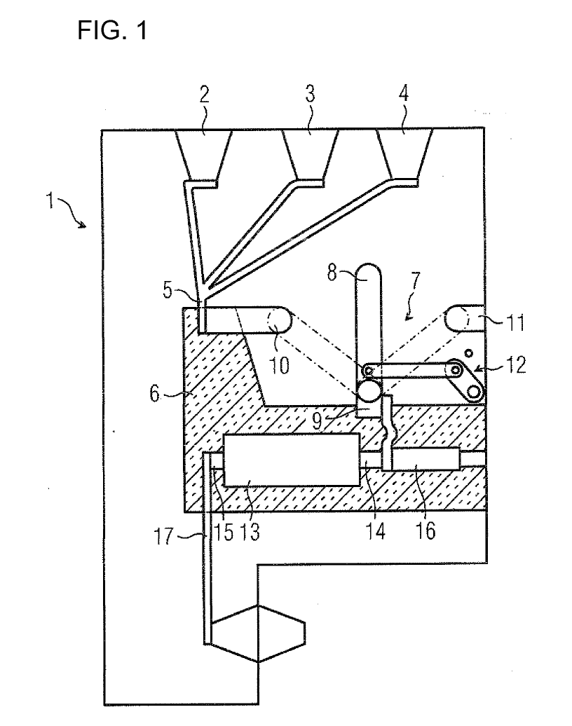

FIG. 1 shows a schematic illustration of a gas-insulated medium-voltage switchgear assembly in a first embodiment;

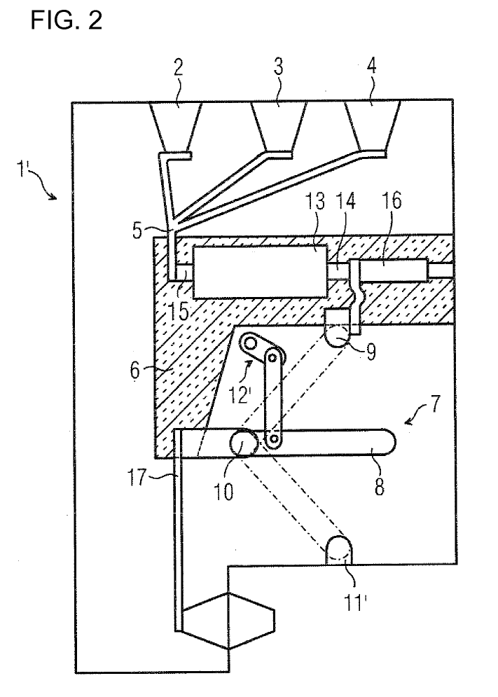

FIG. 2 shows a schematic illustration of a gas-insulated medium-voltage switchgear assembly in a second embodiment.

FIG. 1 illustrates a gas-insulated medium-voltage switchgear assembly 1, in which busbars 2, 3, 4 are connected to an insulating body 6 of the medium-voltage switchgear assembly 1 via a connection 5 on the busbar side. A switch disconnector 7 comprises a movable switching contact 8, which is mounted pivotably at a first contact point 9 and whose free end is capable of being pivoted between a further contact point 10 and a grounding contact 11, which is arranged on the housing of the medium-voltage switchgear assembly 1; the further contact point 10, which is conductively connected to the connection 5 on the busbar side, is also in the form of a bearing point and is therefore prepared for bearing of the movable switching contact 8 of the switch disconnector 7. The contact points 9 and 10 are integral and are partially embedded in the insulating body. However, it is also possible and can be advantageous for the two contact points to each be designed in a plurality of parts by in each case one contact carrier being embedded in the insulating body in such a way that a comparatively short end protrudes and a contact element or bearing element is fastened at this short end. The switch disconnector 7 is mechanically coupled to an actuating mechanism 12, which can be driven externally. A circuit breaker 13 with connections 14, 15 for a movable contact (not illustrated) and a fixed contact (likewise not illustrated) is embedded in the insulating body 6. The movable contact of the circuit breaker 13 is actuated via an externally drivable actuating device 16 for closing and opening the circuit breaker 13. The connection 14 is conductively connected to the first contact point 9 of the switch disconnector 7 and the connection 15 is conductively connected to an outgoing cable 17.

The medium-voltage switchgear assembly shown in FIG. 1 is generally used in primary energy distribution systems, but it is also easily possible for it to be used in secondary distribution systems.

The movable switching contact 8 can be pivoted between three possible positions. In a first position illustrated by dashed lines, the free end of the movable switching contact is connected to the further contact point 10. In this position, a connection can be formed between the busbars 2, 3, 4 and the outgoing cable 17 as a result of tripping of the actuating device 16 and closing or opening of the contacts of the circuit breaker 13, with the result that the circuit breaker 13 is used for switching or interrupting the energy provided at the busbars at the outgoing cable 17. In a second position, which is likewise illustrated by dashed lines, the free end of the movable switching contact 8 is in contact with the grounding contact 11 of the medium-voltage switchgear assembly 1. In this position of the switch disconnector 7, a grounding operation of the medium-voltage switchgear assembly 1 is prepared. The circuit breaker 13 is used for grounding purposes by the contacts of the circuit breaker 13 being closed via the actuating device 16. If the contacts of the vacuum interrupter 13 are closed and the switch disconnector 7 is located in its second position, the gas-insulated medium-voltage switchgear assembly 1 is grounded. In a third position, which is illustrated by a continuous line, the free end of the movable switching contact 8 is not connected to any of the contact points 9, 10; this position corresponds to a switched-off position of the gas-insulated medium-voltage switchgear assembly 1. The pivoting of the movable switching contact 8 between the various positions is in this case carried out via the externally accessible actuating mechanism 12.

FIG. 2 shows a gas-insulated medium-voltage switchgear assembly 1′, which is preferably designed as a gas-insulated medium-voltage switchgear assembly 1′ preferably for a secondary energy distribution system using substantially identical component parts, but can also be used for primary distribution systems. With this gas-insulated medium-voltage switchgear assembly 1′, the insulating body 6 is rotated through 180° about its longitudinal axis in comparison with the arrangement in FIG. 1, the further contact point 10 is connected to the outgoing cable 17 and is now also used as the bearing point for the movable switching contact 8 of the switch disconnector 7. The first contact point 9 is conductively connected to the connection 14 for the movable contact of the circuit breaker 13. The connection 15 for the fixed contact of the circuit breaker 13 is connected to the busbars 2, 3, 4. A grounding contact 11′, which is provided for the purpose of grounding the medium-voltage switchgear assembly 1′, is arranged opposite the first contact point 9.

If the movable switching contact 8 of the switch disconnector 7 is located in a first position (illustrated by dashed lines) in which its free end is connected to the first contact point 9, the circuit breaker 13 is used for transmitting the energy available at the busbars 2, 3, 4 to the outgoing cable 17. The movable switching contact 8 can be pivoted about the further contact point 10 into a second position (likewise illustrated by dashed lines) in which the free end of the movable switching contact 8 is connected to the grounding contact 11′ via the externally drivable actuating mechanism 12′ of the switch disconnector 7. In this second position, the outgoing cable 17 of the gas-insulated medium-voltage switchgear assembly 1′ is grounded. The third position, which is illustrated by a continuous line, corresponds to the switched-off position of the gas-insulated medium-voltage switchgear assembly 1′.

1-2. (canceled)

3. An insulating body assembly for a medium-voltage switchgear assembly with a connection on a busbar side and an outgoing cable, the insulating body comprising:
an insulating body;
a circuit breaker embedded in said insulating body;
a first contact connected to said circuit breaker and forming a first bearing point for a movable switching contact of a switch disconnector, and a further contact point for said movable switching contact, said further contact point forming a second bearing point for said movable switching contact;
wherein said movable switching contact is optionally mounted at said further contact point instead of at said first contact point, and said further contact point is optionally connected to the outgoing cable instead of to the connection on the busbar side.

4. The insulating body according to claim 3, which comprises an actuating mechanism for connecting said movable switching contact to a grounding contact, and wherein said grounding contact is optionally arranged opposite said first contact point instead of opposite said further contact point.
